(19) United States
(12) Patent Application Publication
(10) Pub. No.: US 2010/0180414 A1
(43) Pub. Date: Jul. 22, 2010

(54) INTERNAL HINGE VERTICAL AXIS WIND TURBINE ERECTION METHOD

(75) Inventor: Leon Richartz, Carson City, NV (US)

Correspondence Address: DLA PIPER LLP (US ), 2000 UNIVERSITY AVENUE, EAST PALO ALTO, CA, 94303-2248, US

(73) Assignee: Great Wind Enterprises, Inc., Alameda, CA (US)

(21) Appl. No.: 12/358,160

(22) Filed: Jan. 22, 2009

(51) Int. Cl. B23P 15/04

(52) U.S. Cl. 29/23.51; 29/889

(57) ABSTRACT

A system and method for erecting a vertical axis wind turbine are disclosed that uses an internal hinge.

### FIELD

A system and method for erecting a vertical axis wind turbine are provided.

### BACKGROUND

A Darrieus-type vertical axis wind turbine (“VAWT”) typically has two or three curved blades joined at the ends to the top and bottom of a rotatable, vertical tower. The two or more blades bulge outward to a maximum diameter about midway between the blade root attachments points at the top and bottom of the tower. See U.S. Pat. No. 1,835,018 to D. J. M. Darrieus for a basic explanation of a VAWT. The rotatable, vertical tower with the blades attached will be referred to herein as a tower or tower assembly. A typical VAWT supports the bottom of the tower on a lower bearing assembly, which in turn is elevated off the ground by a base. The rotation of the tower is coupled to and drives an electrical generator, typically located in the base, which produces electrical power as the tower rotates. The top of the tower is supported by an upper bearing assembly that is held in place by guy wires or other structures. See U.S. Pat. No. 5,531,567 which shows examples of two typical VAWTs.

A key component of the VAWT is the blades, which interact with the wind to create lift forces that rotate the tower and drive the generator. The blades typically have a symmetrical or semi-symmetrical airfoil shape in cross-section with a straight chord that is oriented tangential to the local radius of the turbine. The tower rotates to give the blades greater velocity than the wind, and the angle of attack that the wind generates causes lift forces on the blades that maintain rotation of the tower. The lift forces are periodic because each blade goes through two phases of no lift per revolution when the blade is moving either straight up-wind or straight down-wind. In addition to the wind-generated lift forces, centrifugal forces also act on the blades.

A slender structure like a VAWT blade attached by its ends to a rotating axis tends to take the shape of a troposkein when the tower rotates. A troposkein is the shape that a linearly-distributed mass like a skipping rope would take under centrifugal force when the rope is spun around an axis. Considering just centrifugal forces, the spinning rope takes the troposkein shape and is loaded in pure tension because it has negligible stiffness or resistance to bending. It is desirable for a VAWT blade to have a troposkein shape in order to minimize bending stresses and fatigue loads, but a practical problem is how to design a VAWT blade so that it is flexible enough to assume a troposkein shape yet rigid enough to withstand operating loads, including the significant loads that result from gravity.

In general, to generate more power, it is desirable for a VAWT to increase the swept area because it increases wind energy capture on a per turbine basis. One of the ways to increase the swept area is to increase the height of the mast. When the height of the mast is increased, the length of the blades is consequently increased. When a VAWT is scaled up to produce more energy, it is very cumbersome to erect the VAWT structure without using a large crane. Thus, it is desirable to provide a process for erecting a Darrieus-type vertical axis wind turbine and it is to this end that the disclosure is directed.

### BRIEF DESCRIPTION OF THE DRAWINGS

FIG. 1 is a side view of an assembled Darrieus-type vertical axis wind turbine (VAWT) in an assembly position;

FIG. 2 shows a top view of a VAWT structure and a gin pole assembly;

FIG. 3 illustrates an example of an implementation of a base portion hinge;

FIG. 4 illustrates an example of an implementation of a mast hinge;

FIGS. 5 and 6 illustrate the operation of the base portion hinge and mast hinge together to act as an internal hinge during the erecting of a vertical axis wind turbine;

FIGS. 7A and 7B illustrate an example of an implementation of the base of the vertical axis wind turbine;

FIGS. 8-10 illustrate details of the mast support towers that may be used with the internal hinge erection method;

FIG. 11 illustrates details of preparing a bottom of the mast of the vertical axis wind turbine;

FIGS. 12, 13A and 13B illustrate details of an example of the strut to blade assembly of the vertical axis wind turbine;

FIGS. 14-18 illustrate details of the vertical axis wind turbine that can be erected using the internal hinge method;

FIG. 19 illustrates details of a first internal hinge vertical axis wind turbine erection method; and

FIG. 20 illustrates details of a second internal hinge vertical axis wind turbine erection method.

### DETAILED DESCRIPTION OF ONE OR MORE EMBODIMENTS

The disclosure is particularly applicable to a VAWT as shown below and it is in this context that the disclosure will be described. It will be appreciated, however, that the method and system has greater utility since it can be used to erect other types of VAWT or wind turbines generally. In accordance with the illustrated embodiments, the known components of a VAWT structure are assembled on the ground and the completed VAWT structure is erected as a single unit without using a large crane is as typically required that is less safe, the site access will limit the maneuverability of the large crane and severely sloped sites would not be suitable for the large crane.

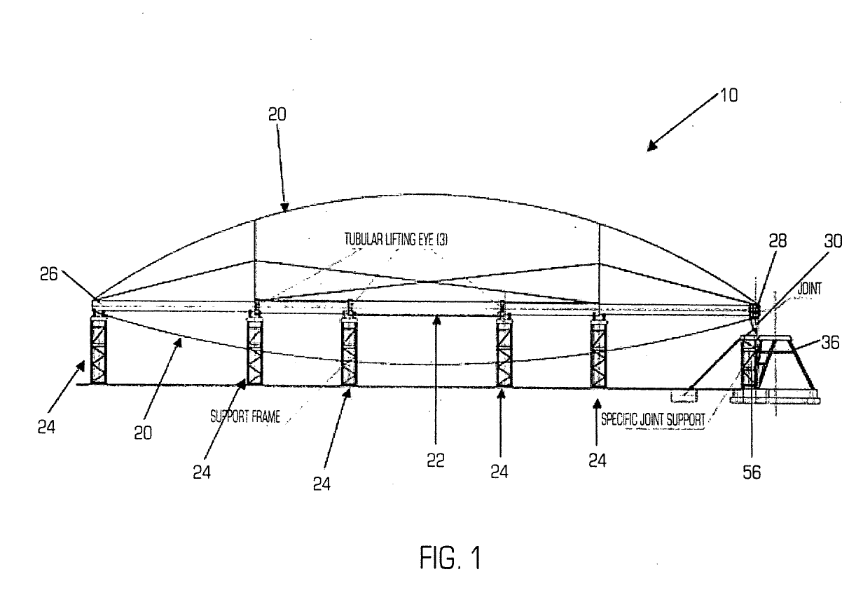

FIG. 1 shows a side view of a VAWT structure 10 with three blades 20 in an assembly position. The VAWT structure 10 may also have a mast 22 and one or more struts 25 connected to the mast that support the blades 20 of the VAWT structure. The VAWT structure that can be erected using the techniques described below may include vertical axis wind turbines that have a 20 to 200 meter diameter, 50 to 400 meter rotor height and weigh 20 to 3000 tons.

In one embodiment, a plurality of support frames 24 are designed to support the mast 22 of the VAWT structure 10 while it is in the assembly position which may be horizontally. The height of each support frame 24 may be different depending on the site elevation or the terrain of the ground. The mast 22 has a top part 26 and a base part 28. A mast joint 30 attaches to the circumference of the base part 28 of the mast 22 and is designed to position the mast 22 as it is rotated into its operating position so that the mast 22 will fit accurately into a base support 36 that supports the weight of the VAWT structure 10 once it is installed. The base support may also house a turbine that is coupled to the structure 10 and generates power as the blades catch the wind/air flow and turn the wind turbine. A support structure 56 may rotateably connect to the bottom portion of the VAWT structure 10 so that the VAWT structure 10 can be rotated (using a gin pole assembly 32 described below) relative to the support structure 56 so that the bottom of the VAWT structure 10 when erected will interface with the base 36. The mast 22 can be properly positioned during erection with the help of the mast joint 30 because the mast joint allows the structure 10 to be rotated from a horizontal position (the position in which it is built and assembled) into the vertical operating position.

In order to erect the VAWT structure 10 that may weigh more than 100 tons using the method of erection described below, it is only necessary to tilt/rotate the mast 22 (and the VAWT structure 10) from horizontal to vertical since the rest of the VAWT structure 10 is attached to the mast 22 as described in U.S. Pat. No. 5,531,567. To erect the mast 22 without using a large capacity crane, such as a 240-ton or larger crane, accessorial structures/devices that are part of an erection kit for a VAWT are used to erect the VAWTs as described below. The method for erecting the VAWT is described below.

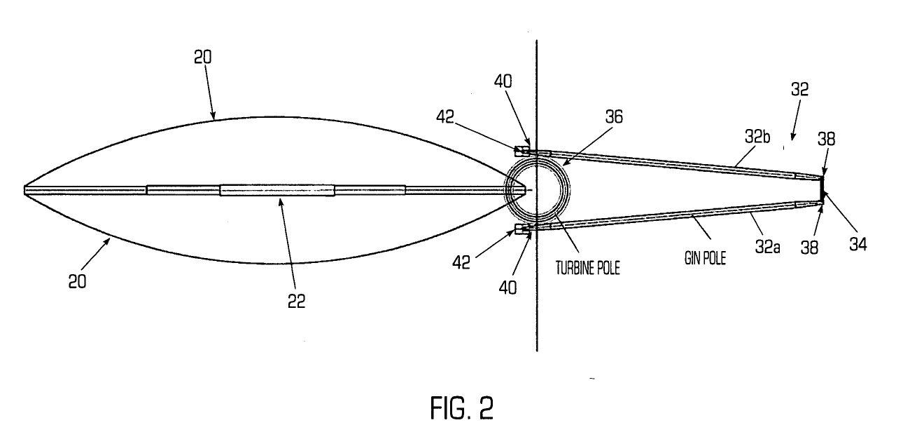

FIG. 2 shows a top view of the VAWT structure 10 (and the mast 22 and blades 20) with a gin pole assembly 32 that are used to erect the VAWT structure 10. In one implementation, the gin pole assembly 32 may include a first gin pole 32a and a second gin pole 32b that are joined together at an upper end 38 of each gin pole by a connector 34. Each gin pole also has a bottom end 40 that is pivotally anchored to the ground by a gin pole base 42. The gin pole bases 42 allow the gin pole to be pivoted about the base. In one implementation, the first and second gin poles 32a, 32b are positioned horizontally opposite each other and on opposite sides of the VAWT structure 10 so that the center of the mast is lined up with a center of the circular turbine base 36 and the VAWT during installation is balanced in at least one axis. In the implementation with two gin poles 32a, 32b, the two gin poles 32a, 32b initially rest on the ground symmetric to the center line cutting through the center line of the mast 22. In one implementation, the rotation axis of each gin pole 32 (at the base 42) is between 1 to 12 meters away from the center of the turbine base. For example, the rotation axis of each gin pole may be 3 meters away from the center of turbine base. The lifting height of gin pole 32 is 60 m and its lifting capacity is 240 tons. The gin pole may be 50% to 65% of the overall height of the vertical axis wind turbine.

For a VAWT with an overall height of 130 meters, the typical erection method would require a crane with a lifting height of at least 120 meters and 150 tones of lifting capacity. However, the use of the gin pole assembly 32 eliminates the need for a large crane to erect a VAWT structure 10. For the VAWT with the overall height of 130 meters, the gin pole assembly is only 60 meters long and can be used to lift more than 240 tones. However the erection method described below can be applied to significantly larger VAWTs 10 using longer gin pole assemblies 32. In general, this technique requires the gin pole assembly 32 that is only half the overall height of the mast of the VAWT structure 10, yet allows for greater lifting capacity.

A new method for erecting a vertical axis wind turbine using the gin poles is now described. The new method utilizes new installation components which are also described below. In the new erection method, a hinge joint that may be built into the mast 22 and base structure 36 as described below may be used so that when the VAWT is assembled, it can be tilted into position about the hinge joint and thus provides an internal hinge erection method. The internal hinge erection method simplifies the assembly and erection process to make it safer, cheaper, and faster. The internal hinge erection method continues the use of gin poles and winches described above and as described further below.

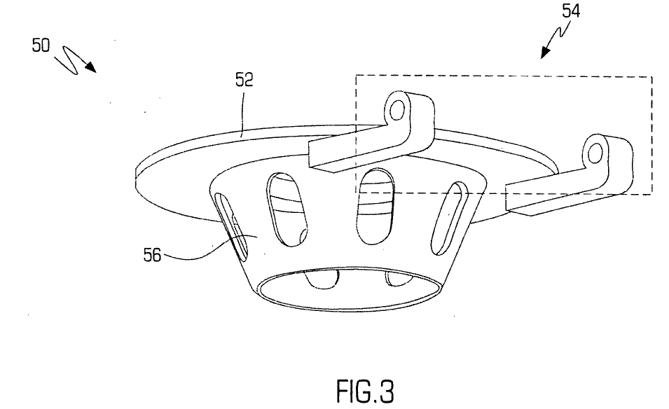

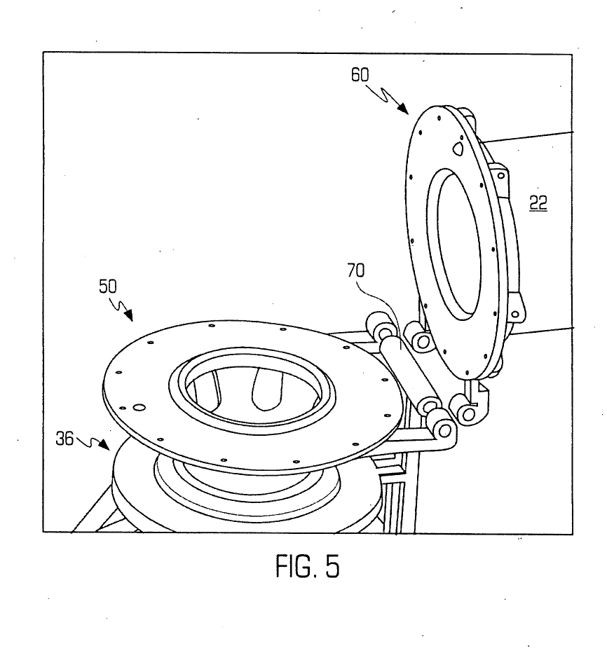

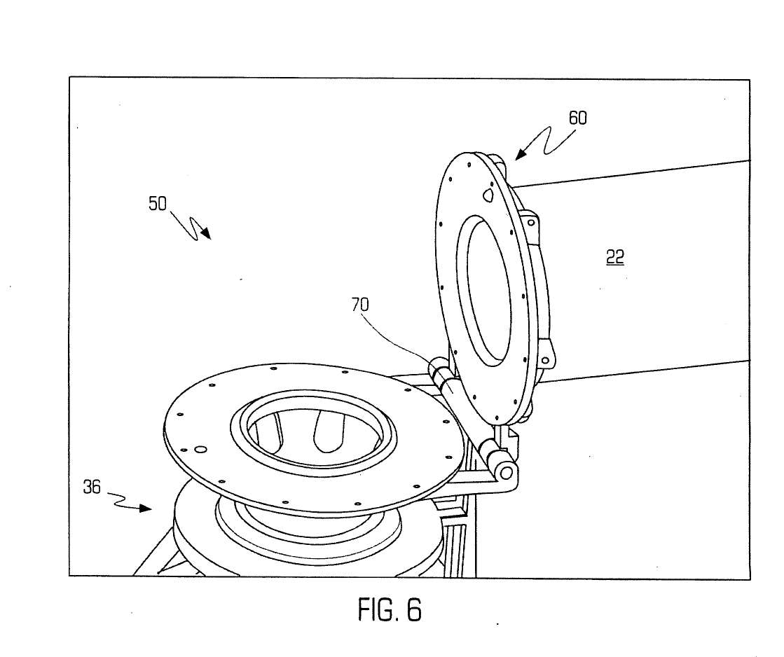

FIG. 3 illustrates an example of an implementation of a base portion hinge 50 that forms part of the hinge joint that may be used during the internal hinge erection method. The base portion hinge 50 may be fitted onto the base 36 discussed above and allows rotation of a structure connected to it relative to the base 36. In the implementation shown, the base portion hinge 50 may be made out a metal, such as steel, and may further comprise a base portion 52 that may rest on the base 36 when attached to the base 36, a hinge portion 54 that allows the base portion hinge to rotate relative to the base 36 and a lower portion 56 that may rest inside of the base 36 when the base portion hinge is resting in the base as shown in FIGS. 5 and 6 which are described below.

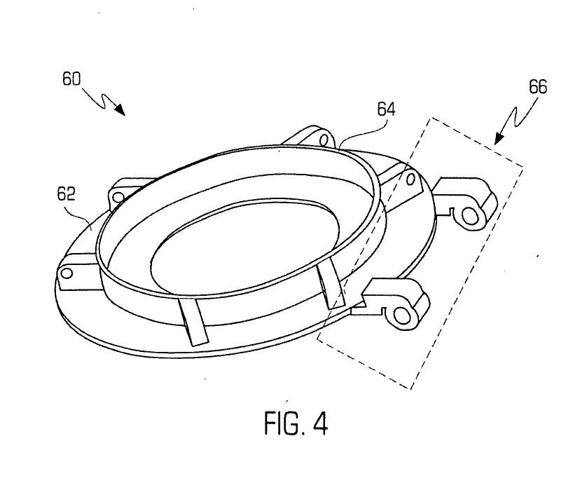

FIG. 4 illustrates an example of an implementation of a mast hinge 60 that forms part of the hinge joint that may be used during the internal hinge erection method. The mast hinge 60 may be fitted onto the mast 22 discussed above and affixed and allows rotation of a structure connected to it relative to the mast 22. In the implementation shown, the mast hinge 60 may be made out a metal, such as steel, and may further comprise a body portion 62 that fits around the mast, one or more tabs 64 and a hinge portion 66 that allows the mast hinge 60 to rotate relative to the base mast 22 as shown in FIGS. 5 and 6 which are described below in more detail. The one or more tabs 64 that are around the circumference of the mast hinge are used to couple the one or more blades (three blades in one embodiment) that make up the vertical axis wind turbine.

FIGS. 5 and 6 illustrate the operation of the base portion hinge and mast hinge together to act as an internal hinge during the erecting of a vertical axis wind turbine. The internal hinge when assembled as shown in FIG. 6 is a mechanism used to align the mast 22 to the base 36 and a drive train that is contained in the base. Until the erection process begins, the two parts of the hinge are disconnected and horizontally separated to allow rotor assembly as shown in FIG. 5. As shown in FIG. 5, the base portion hinge 50 is shown above the base 36 and can be secured to the base 36 and the mast hinge 60 is coupled/attached to the mast 22 as shown. The internal hinge may also include a portion 70 that rests between and aligns the hinge portions as shown in FIG. 6 so that a mechanism, such as a bolt or pin, can be threaded from the hinge portions and the portion 70 to rotatably secure the two hinge portions together so that the mast 22 can rotate relative to the base 36 thus allows the mast to be rotated into a vertical installed position.

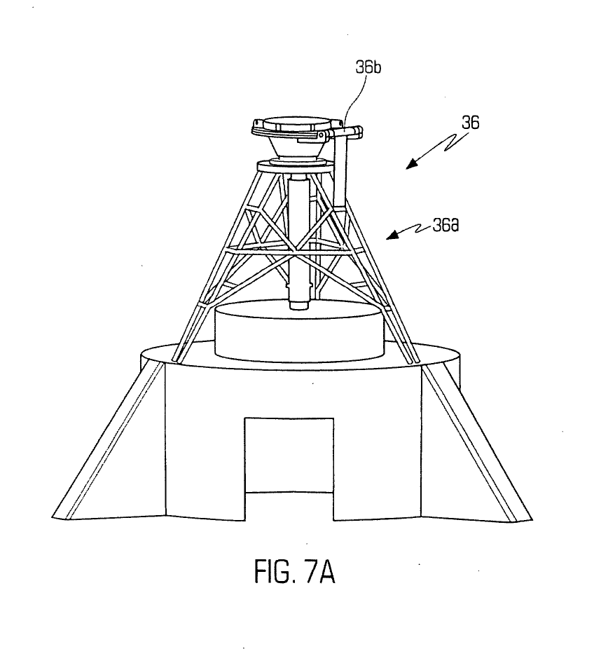

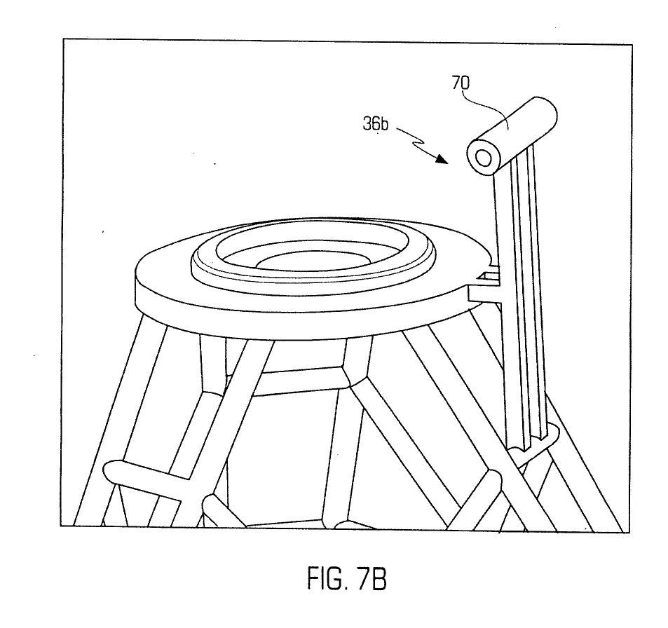

FIGS. 7A and 7B illustrate an example of an implementation of the base 36 of the vertical axis wind turbine. The base 36 may include a base portion 36a that is anchored to the ground and sturdy enough to withstand the loads placed on it as the vertical axis wind turbine is rotated and titled into position as described below. The base 36 may further comprise a hinge holder 36b that is attached to the base portion 36a and includes the portion 70 as shown in FIG. 7B.

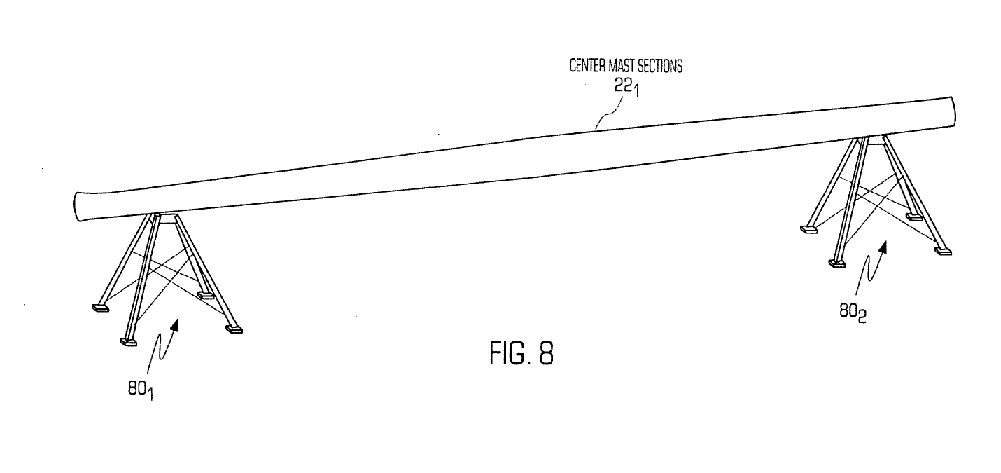

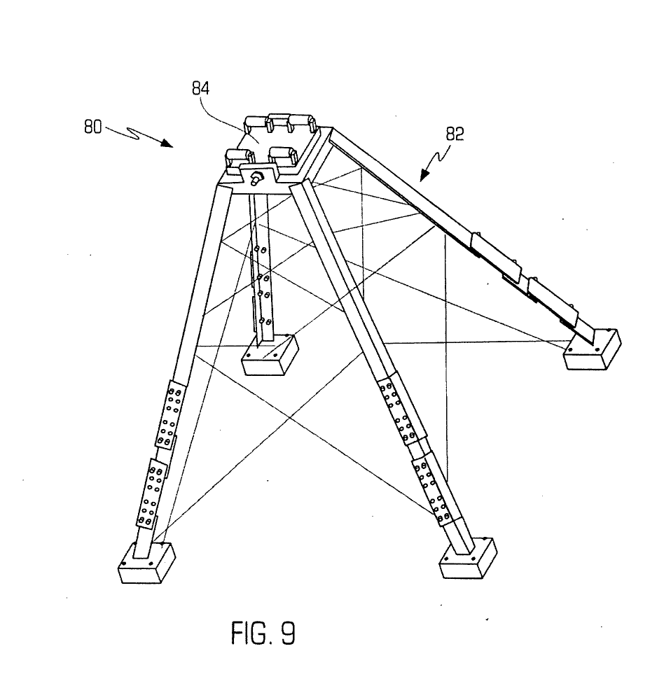

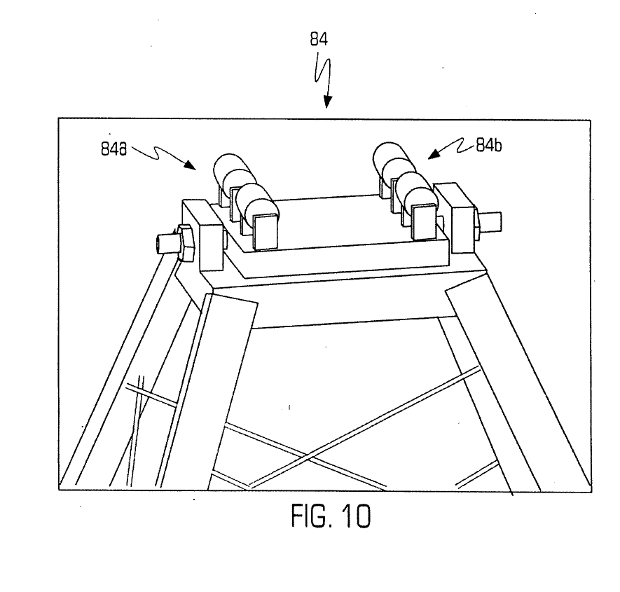

FIGS. 8-10 illustrate details of the mast support towers that may be used with the internal hinge erection method. In the internal hinge erection process, a first and second mast support tower 801, 802 as shown in FIG. 7 may be used to support a center portion 22₁ of the mast 22. Each mast support tower as shown in FIG. 8 has a stand portion 82 that is a predetermined height and a roller portion 84 at the top of the stand portion. Each mast support tower allow three degrees of motion. In particular, as shown in FIG. 9, each roller portion 84 has a first set of rollers 84a and a second set of roller 84b wherein one set of rollers allows the mast to be rotated so that strut and blade assembly is always done low to the ground as described below. The second set of rollers allows the assembled rotor to position the upper and lower hinge components properly for connection. The tension in the mast tower cross bracing can be varied to insure that the hinge components mate properly as well as to allow mast straightening prior to erection.

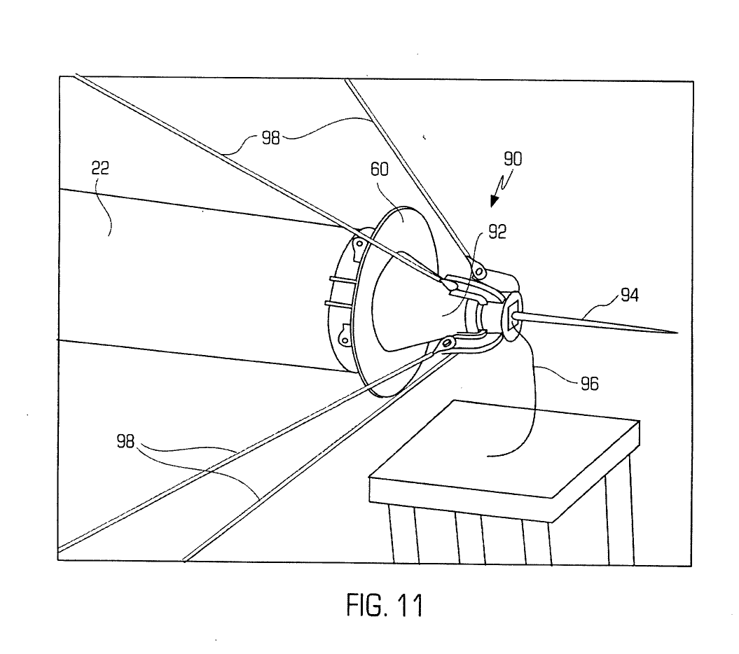

FIG. 11 illustrates details of preparing a bottom 90 of the mast of the vertical axis wind turbine. At the bottom of the mast, a set of instruments 92 may be connected to the mast underneath the mast hinge 60 as shown and may be secured to the hinge portion. In addition, a lightening protection rod 94 is installed at the base of the mast along with a set of wires 96 wherein some of the wires connect the set of instruments to other circuitry and some of the wires connect the lightening protection rod to ground. In addition, one or more guy wires 98 may be connected bottom 90 of the mast which are used during the assembly and erection process described below.

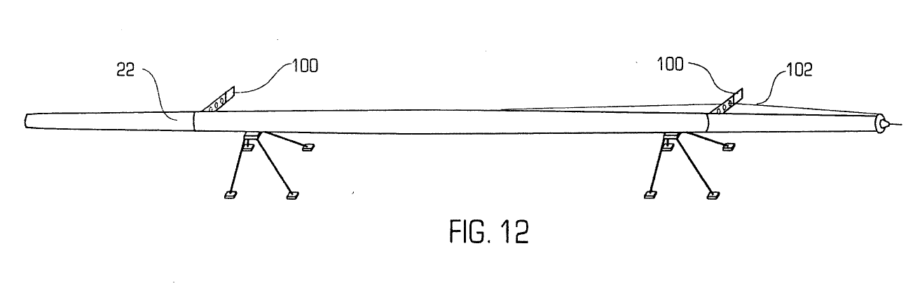

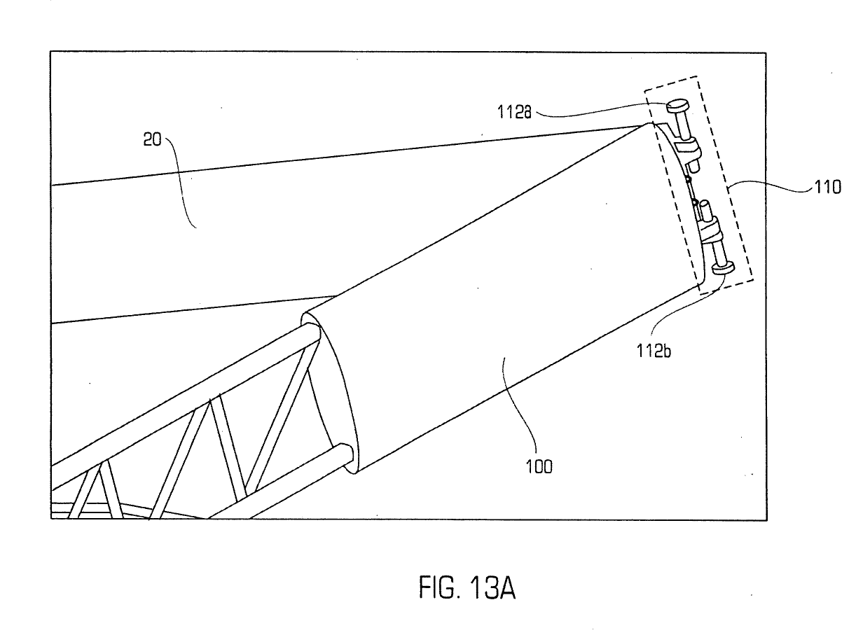

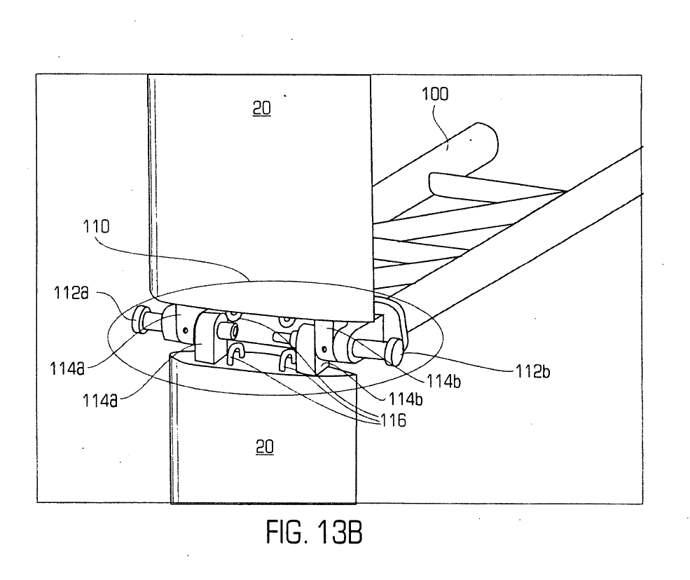

FIGS. 12, 13A and 13B illustrate details of an example of the strut to blade assembly of the vertical axis wind turbine. At a position of 60 degrees (where 180 degrees is straight up and 0 degrees is straight down), lower and upper strut assemblies 100 are attached to the mast as shown in FIG. 12. If diamond stays 102 are employed then they are installed at this time as shown in FIG. 12. One or more diamond stays may be used to maintain mast stiffness during high winds. If the site for installation has peak winds that are above a certain threshold, then the diamond stays are used. The threshold for using the diamond stays is when the high wind survival conditions exceed the stiffness and cyclic fatigue limits of the mast. Then the blade sections (B1, B2 and B3 on FIG. 15) are connected to the mast 22 and struts and connected with pins. FIGS. 13A and 13B shows details of the strut-to-blade joints with FIG. 13B showing the strut 100 connected to opposite ends of two blades. The end of each strut 100 may have a joint 110 through which two pins/bolts 112a, 112b may be inserted and secured to rotatably secure the end of the blades to the strut. The end of each blade, as shown in FIG. 13B, may have a first and second tab 114a, 114b that can be rotatably connected to the strut. The end of each blade may also have one or more lifting points 116 that may be used during the construction of the vertical axis wind turbine to lift/move the blade portions.

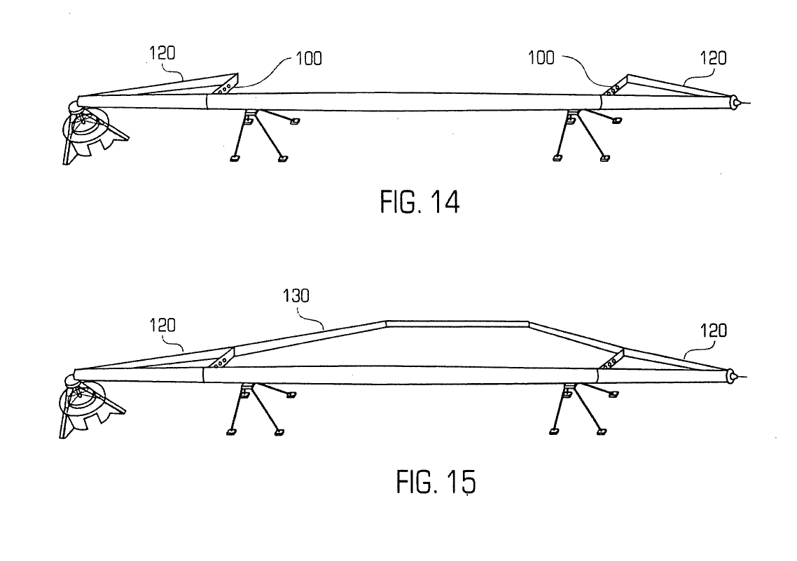

FIGS. 14-18 illustrate details of the vertical axis wind turbine that can be erected using the internal hinge method. In particular, FIG. 14 illustrates that a NACA section 120 of each blade (NACA airfoils) is installed between the bottom and top portions of the mast 22 and the strut 100 as shown. Each NACA section is connected with pins 112a, 112b that are partially inserted to leave sufficient clearance for the other blade portions. As shown in FIG. 15, an S824 blade section 130 to be installed and the joint pins 112a, 112b are fully inserted. Finally the two joint pins are connected to reduce potential blade flutter.

The vertical axis wind turbine may be erecting using two different methods, each of which is described below in more detail. The difference between the two is in the first method only one 120 degree rotation of the mast is made while in the alternative method, a wind screen is installed as described below and two 120 degree rotations are required.

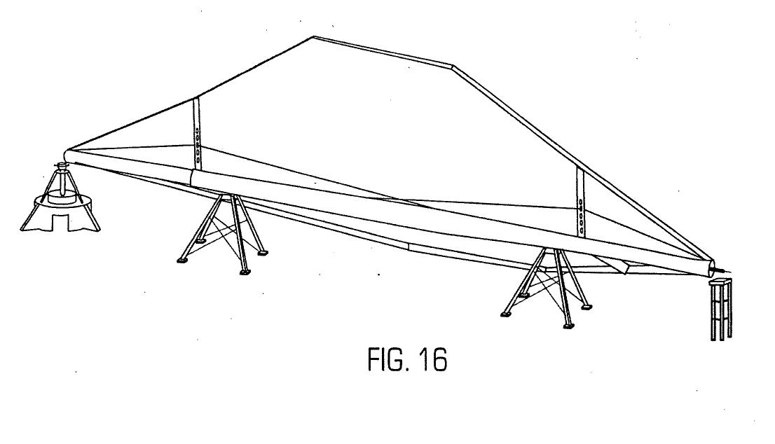

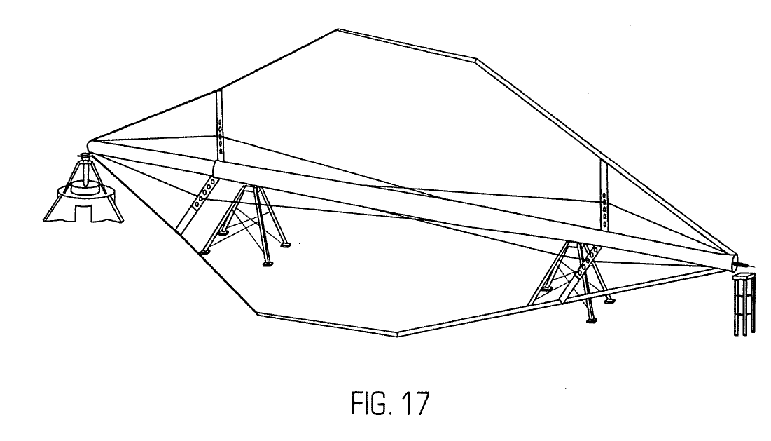

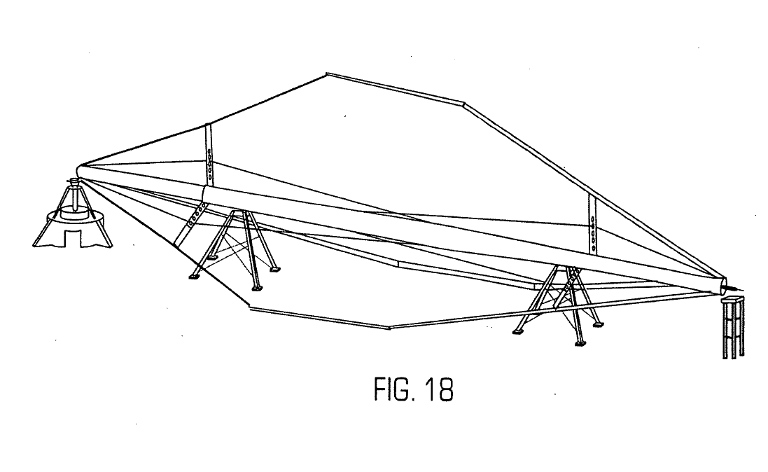

FIGS. 16-18 illustrate the first method for erecting the vertical axis wind turbine using the internal hinge. A small winch may be used to rotate the mast with one set of struts and blades (and diamond stays if used) from the 60 degree orientation into the 180 degree position. The process described above to install the struts and blades is repeated until a second set of strut assemblies, diamond stays (if used), blades, and bullet blade fairings are attached to the mast 22 as shown in FIG. 17. At the same time as the installation of the second set of strut assemblies; diamond stays (if used ); blades; and bullet fairings the third set of strut assemblies; diamond stays (if used); blade segments; and bullet fairings can be installed in the 300 degree position as shown in FIG. 18.

Using the small winch, the mast and rotor assembly is rotated 120 degrees so that the second set of strut assemblies, diamond stays (if used), blades, and fairings are in the 180 degree orientation. The small winch is again used to rotate the mast another 120 degrees and the third set of strut assemblies, diamond stays (if used), blade segments, and bullet fairings are attached to the mast in the 60 degree orientation as shown in FIG. 18.

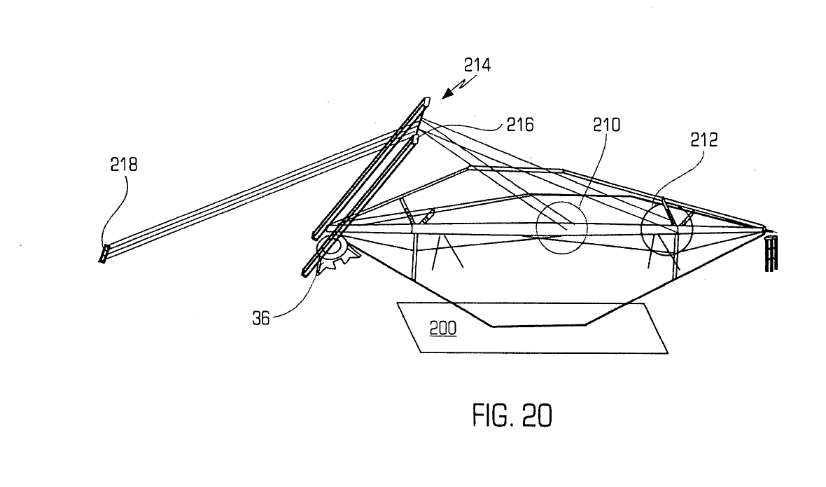

In the alternative method, if the wind interference is “too” high then a wind screen 200 (a as shown in FIG. 20) can be installed running the full length of the mast and the first set of strut assemblies; diamond stays (if used ); blade segments; and bullet fairings are installed at a 60 degree orientation down wind of the wind screen. Both methods now follow the same remaining processes as described below.

Thus, in either method, once all of the struts and blades have been assembled as shown in FIG. 18, the assembled VAWT is positioned so that the mast hinge 60 and base portion hinge 50 can be pinned coupled together. This process can be facilitated by jacking the mast up onto a second set of rollers and small winch may be used to positions the hinges. In addition the tension in the mast support towers are varied to perfectly align the hinges and to insure the mast is straight prior to erection.

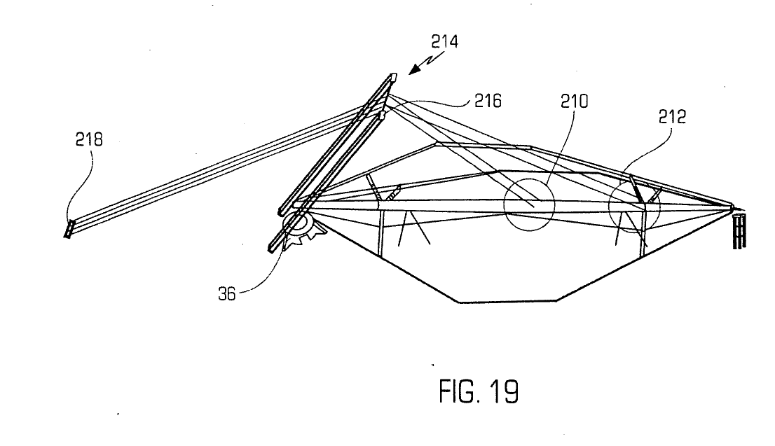

As shown in FIG. 19 for the first method and FIG. 20 for the alternative method, lifting cables may be bent around and threaded through the lifting points on either side of the center mast-to-mast flange 210 and at the upper mast-to-center mast flanges 212. The lifting cables may be secured to the gin pole transom bar 214 using pulley blocks and cables 216. The assembly is connected to the lifting winches 218.

The winches and gin poles are used to tilt the VAWT onto the base 36 wherein the VAWT rotates about the hinge into the base 36. The guy cables may be then secured to the guy anchors and the guy cable tension properly set and the lifting cables are released. Then, the cables and pulley blocks are released from the gin pole transom bar and the gin poles and winches and the blade/mast support towers are removed. The VAWT is now in the vertical installed position and ready for generator and brake testing and grid hook-up.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for erecting a vertical axis wind turbine,
providing an assembled vertical axis wind turbine structure having a mast and a mast internal hinge portion;
providing a base portion anchored to the ground having a base internal hinge portion;
connecting the mast internal hinge portion to the base internal hinge portion to rotatably connect the assembled vertical axis wind turbine structure to the base portion by the internal hinge;
positioning a gin pole assembly adjacent to the assembled vertical axis wind turbine structure; and
rotating the assembled vertical axis wind turbine structure about the internal hinge to a vertical installed position using the gin pole assembly without a crane.

2. The method of claim 1 further comprising installing wind shield to the assembled vertical axis wind turbine structure before the assembled vertical axis wind turbine structure is rotated to a vertical installed position.

3. The method of claim 1, wherein positioning a gin pole assembly further comprises positioning the gin pole assembly so that the axis of rotation of the gin pole assembly is a predetermined distance from a center of the assembled vertical axis wind turbine structure.

4. The method of claim 3, wherein the predetermined distance is 1 to 12 meters.

5. The method of claim 4, wherein the predetermined distance is 3 meters.

6. The method of claim 1, wherein providing an assembled vertical axis wind turbine structure further comprises positioning the assembled vertical axis wind turbine structure substantially horizontally on one or more support frames.

7. The method of claim 3, wherein positioning the gin pole assembly further comprises anchoring a first gin pole along a first side of the assembled vertical axis wind turbine structure, anchoring a second gin pole along a second side of the assembled vertical axis wind turbine structure and connecting the first and second gin pole together.

8. The method of claim 1, wherein rotating the assembled vertical axis wind turbine structure to a vertical position further comprises lifting the gin pole assembly to a starting position and using a gin pole erection block to rotate the gin pole assembly and the assembled vertical axis wind turbine structure to a substantially vertical position.

9. The method of claim 8 further comprising attaching a set of start erection cables onto the assembled vertical axis wind turbine structure once the assembled vertical axis wind turbine structure is in the vertical installed position.

10. The method of claim 1, wherein rotating the assembled vertical axis wind turbine structure to a vertical position further comprises rotating the assembled vertical axis wind turbine structure about a support structure.

11. The method of claim 10, wherein rotating the assembled vertical axis wind turbine structure about a support structure further comprises inserting a drive rotor portion of the assembled vertical axis wind turbine structure into a turbine base.

12. A kit for erecting a vertical axis wind turbine, comprising:
a gin pole assembly that is capable of lifting an assembled vertical axis wind turbine from an assembly position to an installed position;
a mast internal hinge portion that is capable of being coupled to a mast of the assembled vertical axis wind turbine; and
a base portion capable of being anchored to the ground and supporting the assembled vertical axis wind turbine, the base portion having a base internal hinge portion that is capable of being rotatably coupled to the mast internal hinge portion to assist the erecting of the assembled vertical axis wind turbine.

13. The kit of claim 12 further comprising a wind screen that is capable of being attached to the assembled vertical axis wind turbine to provide a wind shield for the assembled vertical axis wind turbine during erection.
